(19) United States
(12) Patent Application Publication
(10) Pub. No.: US 2014/0036146 A1
(43) Pub. Date: Feb. 6, 2014

(54) CAMERA MODULE AND ELECTRONIC DEVICE INCLUDING THE SAME

(71) Applicant: LG INNOTEK CO., LTD., Seoul (KR)

(72) Inventor: Yong Nam CHOI, Seoul (KR)

(73) Assignee: LG INNOTEK CO., LTD., Seoul (KR)

(21) Appl. No.: 13/959,231

(22) Filed: Aug. 5, 2013

(30) Foreign Application Priority Data
Aug. 6, 2012 (KR) 10-2012-0085668

(51) Int. Cl. H04N 5/225

(52) U.S. Cl. CPC H04N 5/2254
USPC 348/374

(57) ABSTRACT

An exemplary embodiment of the present disclosure provides one or more pieces of lenses, a housing formed therein with the one or more pieces of lenses, and a PCB (Printed Circuit Board) fixed to the housing, mounted with an image sensor converting an optical image having passed the one or more pieces of lenses to an electrical signal and formed at a bottom surface with a solder ball.

Pursuant to 35 U.S.C.§119 (a), this application claims the benefit of earlier filing date and right of priority to Korean Patent Application No. 10-2012-0085668 filed on Aug. 6, 2012, the contents of which are hereby incorporated by reference in their entirety.

### BACKGROUND OF THE DISCLOSURE

1. Field of Endeavor

The teachings in accordance with exemplary and non-limiting embodiments of this disclosure relate generally to a camera module and an electronic device including the camera module.

2. Discussion of the Related Art

This section provides background information related to the present disclosure which is not necessarily prior art.

In general, a camera module includes a lens unit including lenses, a housing coupled to the lens unit and a sensor unit including an IR (Infrared) filter and an image sensor. The camera module is recently mounted on a mobile phone to perform a function of capturing an image of an object. The image sensor is mounted on a PCB (Printed Circuit Board), where the housing and the PCB are bonded using an adhesive to allow a camera module to be assembled.

A conventional camera module suffers from disadvantages in that a packaging cost of a COB (Chip On Board) sensor in a CSP (Chip Scale Package) type increases and a device mounting space is hard to obtain due to a reflowable lens being directly mounted on the CSP.

Another disadvantage is that the conventional COB type requires a separate FPCB (Flexible PCB) when a substrate and a set (mother board) are connected, resulting in creation of additional components and complexity in connection structure.

### SUMMARY OF THE DISCLOSURE

This section provides a general summary of the disclosure, and is not a comprehensive disclosure of its full scope or all of its features.

The present disclosure provides a camera module and an electronic device including the same.

It should be emphasized, however, that the present disclosure is not limited to a particular disclosure, as explained above. It should be understood that other technical subjects not mentioned herein may be appreciated by those skilled in the art.

In one general aspect of the present disclosure, there is provided a camera module, the camera module comprising:

one or more pieces of lenses;

a housing formed therein with the one or more pieces of lenses; and

a PCB (Printed Circuit Board) fixed to the housing, mounted with an image sensor converting an optical image having passed the one or more pieces of lenses to an electrical signal and formed at a bottom surface using a solder ball.

Preferably, but not necessarily, the housing may be coupled to the PCB by bonding.

Preferably, but not necessarily, a circuit element may be mounted on the PCB inside the housing.

Preferably, but not necessarily, the circuit element may be a passive element.

Preferably, but not necessarily, a lug may be formed at a housing area fixed to the PCB a groove or a through hole inserted by the lug is formed on the PCB.

Preferably, but not necessarily, the groove or the through hole may be formed in a plural number on the PCB.

Preferably, but not necessarily, the lug of the housing may be formed in the same number as that of the groove or the through hole.

Preferably, but not necessarily, the groove or the through hole may be formed at a mutually symmetrical position.

Preferably, but not necessarily, the lug may be formed in a length protruded from a floor surface of the PCB, in a case the housing and the PCB are coupled.

Preferably, but not necessarily, the length of the lug may be formed shorter than a height from the PCB of the solder ball.

Preferably, but not necessarily, the one or more pieces of lenses and the housing may be manufactured with a WLO (Wafer Level Optic) that is a wafer optical element.

In another general aspect of the present disclosure, there is provided an electronic device, the electronic device comprising: one or more pieces of lenses; a housing formed therein with the one or more pieces of lenses;

a camera module including a PCB (Printed Circuit Board) fixed to the housing, mounted with an image sensor converting an optical image having passed the one or more pieces of lenses to an electrical signal and formed at a bottom surface with a solder ball; and

a second substrate coupled to the camera module using the solder ball.

Preferably, but not necessarily, the camera module may be coupled by being reflowed using the solder ball.

Preferably, but not necessarily, the second substrate may be a mother board.

Preferably, but not necessarily, the mother board may be a mother board of display module.

Preferably, but not necessarily, the one or more pieces of lenses and the housing may be manufactured with a WLO (Wafer Level Optic) that is a wafer optical element.

The exemplary embodiment of the present disclosure is advantageously configured such that a camera module itself can be directly mounted on a mother board by fixing a housing installed with camera components to a PCB formed with a solder ball.

Furthermore, the exemplary embodiment of the present disclosure is advantageously configured such that a cost for packaging a camera module using a CSP (Chip Scale Package) of a conventional image sensor can be reduced.

In addition, the exemplary embodiment of the present disclosure is advantageously configured such that a solder ball can be formed at a bottom surface of a PCB mounted with an image sensor to enable a reflow, whereby a circuit element can be mounted on the PCB.

Still furthermore, the exemplary embodiment of the present disclosure is advantageously configured such that a lug provided on a housing can be inserted into a groove or a through hole to enable an easy optical alignment of a lens of the housing and an image sensor mounted on a PCB.

### BRIEF DESCRIPTION OF THE DRAWINGS

In order to explain the principle of the present disclosure, some accompanying drawings related to its preferred embodiments are below reported for the purpose of illustration, exemplification and description, although they are not intended to be exhaustive. The drawing figures depict one or more exemplary embodiments in accordance with the present concepts, by way of example only, not by way of limitations. In the figures, like reference numerals refer to the same or similar elements.

FIG. 1 is a schematic lateral cross-sectional view of a camera module according to an exemplary embodiment of the present disclosure.

FIG. 2 is a schematic lateral cross-sectional view for explaining a detailed configuration of a camera module according to an exemplary embodiment of the present disclosure.

FIG. 3 is a schematic lateral cross-sectional view for explaining a coupled state between a housing and a PCB of a camera module according to an exemplary embodiment of the present disclosure.

FIG. 4 is a schematic plane view illustrating a PCB of FIG. 3.

FIG. 5 is a schematic lateral cross-sectional view for explaining a coupled state between a housing and a PCB of a camera module according to another exemplary embodiment of the present disclosure.

FIG. 6 is a partial cross-sectional view illustrating a state where a lug of FIG. 5 is evenly bonded with solder balls.

### DETAILED DESCRIPTION

Hereinafter, exemplary embodiments of the present disclosure will be described in detail with reference to the accompanying drawings.

In describing the present disclosure, detailed descriptions of constructions or processes known in the art may be omitted to avoid obscuring appreciation of the invention by a person of ordinary skill in the art with unnecessary detail regarding such known constructions and functions. That is, the size and relative sizes of layers, regions and/or other elements in the drawings may be exaggerated or reduced for clarity. Like numbers refer to like elements throughout and explanations that duplicate one another will be omitted.

Accordingly, the meaning of specific terms or words used in the specification and claims should not be limited to the literal or commonly employed sense, but should be construed or may be different in accordance with the intention of a user or an operator and customary usages. Therefore, the definition of the specific terms or words should be based on the contents across the specification.

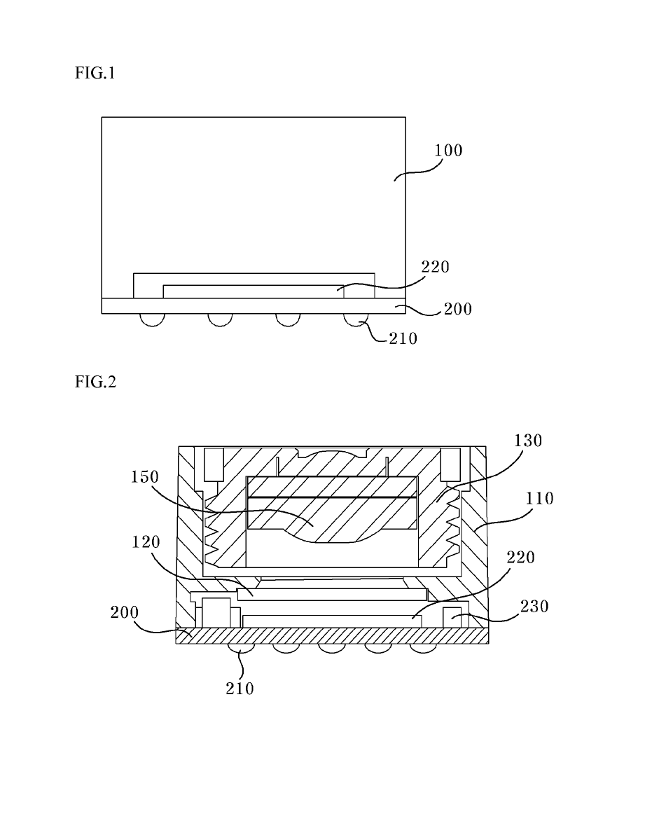

FIG. 1 is a schematic lateral cross-sectional view of a camera module according to an exemplary embodiment of the present disclosure, and FIG. 2 is a schematic lateral cross-sectional view for explaining a detailed configuration of a camera module according to an exemplary embodiment of the present disclosure.

A camera module according to an exemplary embodiment of the present disclosure includes a housing 100 installed therein with a camera component including one or more pieces of lenses 15 incident on by an optical image of an object, and a PCB (Printed Circuit Board, 200) fixed to the housing 100, mounted with an image sensor 220 configured to convert an optical image having passed the lenses to an electrical signal and formed at a bottom surface with a solder ball.

That is, a camera module according to an exemplary embodiment of the present disclosure is advantageous in that the camera module itself can be directly mounted on a mother board by fixing the housing 100 installed with camera components to the PCB 200 formed with a solder ball 210.

Furthermore, the exemplary embodiment of the present disclosure is advantageous in that a cost for packaging a camera module using a CSP (Chip Scale Package) of a conventional image sensor can be reduced. At this time, the housing 100 may be bonded to the PCB 200.

Referring to FIG. 2, a lens assembly 130 and an IR (Infrared) filter 120 are embedded inside the housing 100 of the camera module according to the exemplary embodiment of the present disclosure, where the lens assembly 130 may be coupled to a holder 110. In this case, the IR filter 120 may be mounted in a hollow section formed at the holder 110. The mounting of the IR filter 120 may be performed using an adhesive or a screw thread coupling method.

Meanwhile, the housing including one or more pieces of lenses may be manufactured with a WLO (Wafer Level Optic) that is a wafer optic element, and in this case, the WLO may be bonded to the PCB 200 without recourse to a focusing process after manufacturing.

Furthermore, a circuit element 230 may be mounted at a position of the PCB 200 inside the housing 100, where the circuit element 230 may be a passive element.

In addition, the one or more pieces of lenses 15 is preferably formed with a material capable of withstanding a reflow temperature.

As a result, the exemplary embodiment of the present disclosure is advantageous in that the solder ball 210 can be formed at a bottom surface of a PCB 200 mounted with an image sensor to enable a reflow, whereby a circuit element can be mounted on the PCB.

By way of reference, the exemplary embodiment of the present disclosure is not limited to a shape of a camera module illustrated in the drawing, but may be applied to a FF (Fixed Focus) type camera module or to an AF (Auto Focus) type camera module.

Meanwhile, the camera module according to the exemplary embodiment of the present disclosure may be mounted to a mother board of an electronic device.

That is, the electronic device may include one or more pieces of lenses, a housing formed therein with the one or more pieces of lenses, and a camera module including a PCB (Printed Circuit Board) fixed to the housing, mounted with an image sensor converting an optical image having passed the one or more pieces of lenses to an electrical signal and formed at a bottom surface with a solder ball, and

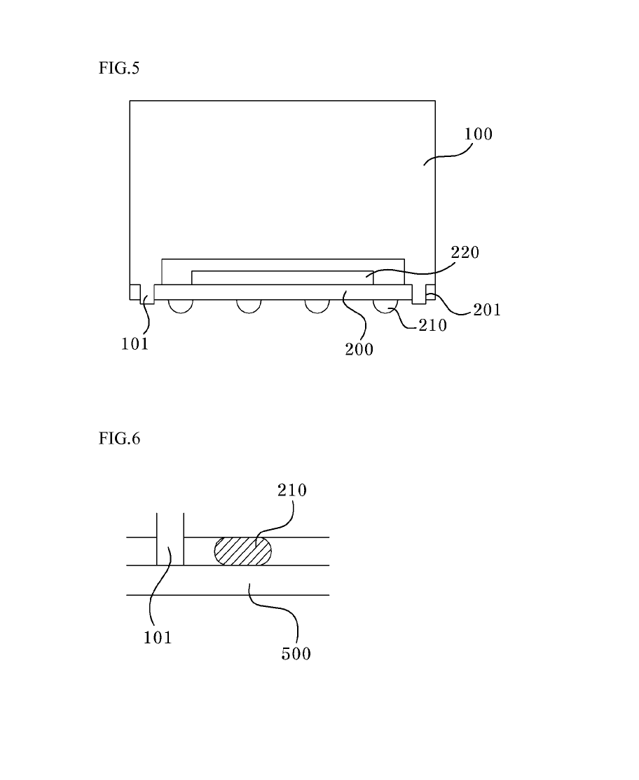

a second substrate (500, see FIG. 6) coupled to the camera module using the solder ball.

The camera module may be reflowed and coupled using the solder ball 210. The second substrate (500, see FIG. 6) may be a mother board of a display module, but the present disclosure is not limited thereto.

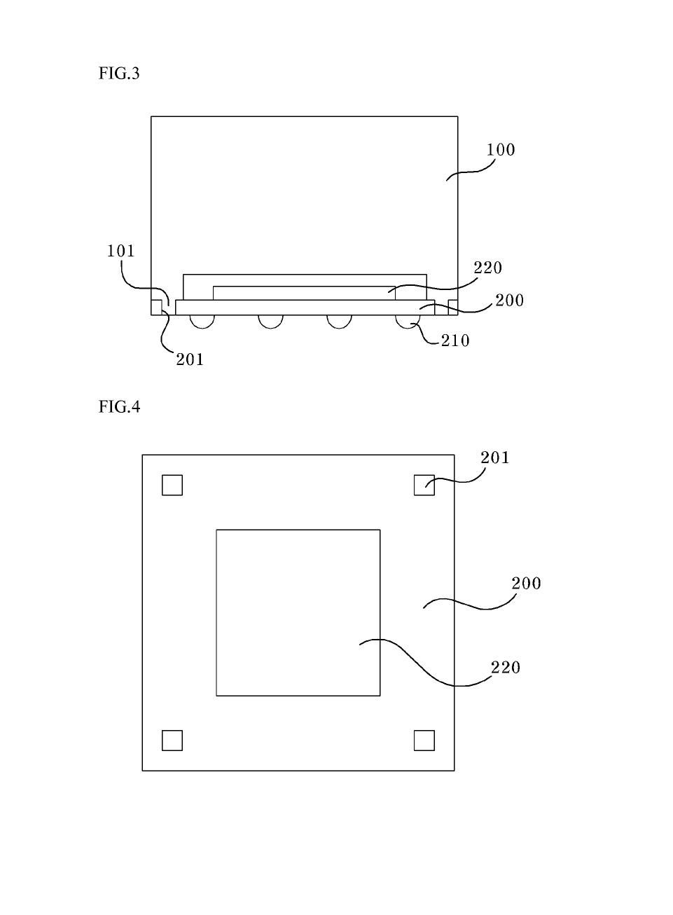

FIG. 3 is a schematic lateral cross-sectional view for explaining a coupled state between a housing and a PCB of a camera module according to an exemplary embodiment of the present disclosure, and FIG. 4 is a schematic plane view illustrating a PCB of FIG. 3.

The camera module according to an exemplary embodiment of the present disclosure is formed with a lug 101 at a housing (100) area fixed to the PCB 200, and a groove or a through hole 201 inserted by the lug 101 is formed on the PCB 200.

Hence, the exemplary embodiment of the present disclosure is advantageous in that the lug 101 provided on a housing 100 can be fixedly inserted into a groove or a through hole 201 of the PCB 200 to enable an easy optical alignment of a lens of the housing 100 and an image sensor mounted on a PCB 200.

Referring to FIG. 4 again, the groove or the through hole 201 may be formed in a plural number on the PCB 200. At this time, the lug 101 of the housing 100 may be also formed in the same number as that of the groove or the through hole 201.

At this time, the groove or the through hole 201 may be formed at a mutually symmetrical position.

That is, the lug 101 provided on a housing 100 is fixedly inserted into a groove or a through hole 201 formed at a mutually symmetrical position to enable an easy optical alignment of a lens of the housing 100 and an image sensor mounted on a PCB 200.

FIG. 5 is a schematic lateral cross-sectional view for explaining a coupled state between a housing and a PCB of a camera module according to another exemplary embodiment of the present disclosure, and FIG. 6 is a partial cross-sectional view illustrating a state where a lug of FIG. 5 is evenly bonded with solder balls.

As mentioned above, the camera module according to an exemplary embodiment of the present disclosure is formed with a lug 101 at a housing (100) area fixed to the PCB 200, and a groove or a through hole 201 is inserted by the lug 101 formed on the PCB 200.

At this time, the lug 101 may be formed in a length protruded from a floor surface of the PCB 200 in a case the housing 100 and the PCB 200 are coupled. At this time, the length of the lug 101 is formed shorter than a height from the PCB 200 of the solder ball 210 of the PCB 200.

The floor surface of the PCB 200 is formed with the solder ball 210, and the solder ball 210 is fused to the mother board 500 to allow supplying an electrical signal to or receiving an electrical signal from the camera module.

Hence, referring to FIG. 6, a lug 101 area protruded from the floor surface of the PCB 200 guides a fused degree of the fusing solder ball 210, and therefore, the solder ball is fused at an even thickness to prevent the camera module from tilting.

Although the present disclosure has been described with reference to a number of illustrative embodiments thereof, it should be understood that numerous other modifications and embodiments can be devised by those skilled in the art that will fall within the spirit and scope of the principles of this disclosure.

What is claimed is:

1. A camera module, the camera module comprising:
one or more pieces of lenses;
a housing formed therein with the one or more pieces of lenses; and
a PCB (Printed Circuit Board) fixed to the housing, mounted with an image sensor converting an optical image having passed the one or more pieces of lenses to an electrical signal and formed at a bottom surface using a solder ball.

2. The camera module of claim 1, wherein the housing is coupled to the PCB by bonding.

3. The camera module of claim 1, wherein a circuit element is mounted on the PCB inside the housing.

4. The camera module of claim 3, wherein the circuit element is a passive element.

5. The camera module of claim 1, wherein a lug is formed at a housing area fixed to the PCB, a groove or a through hole inserted by the lug is formed on the PCB.

6. The camera module of claim 5, wherein the groove or the through hole is formed in a plural number on the PCB.

7. The camera module of claim 6, wherein the lug of the housing is formed in the same number as that of the groove or the through hole.

8. The camera module of claim 5, wherein the groove or the through hole is formed at a mutually symmetrical position.

9. The camera module of claim 5, wherein the lug is formed in a length protruded from a floor surface of the PCB in a case the housing and the PCB are coupled.

10. The camera module of claim 9, wherein the length of the lug is formed shorter than a height from the PCB of the solder ball.

11. The camera module of claim 1, wherein the one or more pieces of lenses and the housing are manufactured with a WLO (Wafer Level Optic) that is a wafer optical element.

12. An electronic device, the electronic device comprising:
one or more pieces of lenses;
a housing formed therein with the one or more pieces of lenses;
a camera module including a PCB (Printed Circuit Board) fixed to the housing, mounted with an image sensor converting an optical image having passed the one or more pieces of lenses to an electrical signal and formed at a bottom surface with a solder ball; and
a second substrate coupled to the camera module using the solder ball.

13. The electronic device of claim 12, wherein the camera module is coupled by being reflowed using the solder ball.

14. The electronic device of claim 12, wherein the second substrate is a mother board.

15. The electronic device of claim 14, wherein the mother board is a mother board of display module.

16. The camera module of claim 1, wherein the one or more pieces of lenses and the housing are manufactured with a WLO (Wafer Level Optic) that is a wafer optical element.
